(19) United States
(12) Patent Application Publication
(10) Pub. No.: US 2023/0406990 A1
(43) Pub. Date: Dec. 21, 2023

(54) REACTIVE COMPOUND FOR PRODUCING POLYURETHANE LAYERS HAVING THERMALLY ACTIVATABLE CATALYST SYSTEMS

(71) Applicant: Benecke-Kaliko AG, Hannover (DE)

(72) Inventor: Andreas Gerken, Hannover (DE)

(73) Assignee: Benecke-Kaliko AG, Hannover (DE)

(21) Appl. No.: 18/245,311

(22) PCT Filed: Aug. 19, 2021
(86) PCT No.: PCT/DE2021/200113

§ 371 Date: Mar. 14, 2023

(30) Foreign Application Priority Data
Sep. 15, 2020 (DE) 10 2020 211 572.9

(51) Int. Cl. C08G 18/22; C08G 18/48; C08G 18/24; C09D 175/08; C08J 7/04

(52) U.S. Cl. CPC C08G 18/227; C08G 18/4812; C08G 18/24; C09D 175/08; C08J 7/0427; C08J 2375/08

(57) ABSTRACT

The present invention relates to reactive compounds for the production of polyurethane layers, said compounds comprising an isocyanate component composed of at least one polyfunctional isocyanate, an oligomer of a polyfunctional isocyanate or an isocyanate prepolymer, a polyol component composed of at least one polyol, and a catalyst system comprising a metal-based catalyst based on a salt or an organometallic compound and a diketo compound having a melting point of ≥15° C. The catalyst system has the characteristic feature of low toxicity and very low reactivity under processing conditions, but can be activated by increasing the temperature, with the result that polyurethanes that have reacted as far as possible can be formed in a short time. The present invention further relates to methods for producing such polyurethane layers, to polyurethane layers produced from the reactive compounds, and to composite structures that comprise such polyurethane layers. In addition, the present invention relates to the use of the specified catalyst systems for the reaction of polyols and polyisocyanates.

The present invention relates to reactive compounds for the production of polyurethane layers, said compounds comprising an isocyanate component composed of at least one polyfunctional isocyanate, an oligomer of a polyfunctional isocyanate or an isocyanate prepolymer, a polyol component composed of at least one polyol, and a catalyst system comprising a metal-based catalyst based on a salt or an organometallic compound and a diketo compound having a melting point of ≥15° C. The present invention further relates to methods for producing such polyurethane layers, to polyurethane layers produced from the reactive compounds, and to composite structures that comprise such polyurethane layers. In addition, the present invention relates to the use of the specified catalyst systems for the reaction of polyols and polyisocyanates.

### PRIOR ART

Polyurethane systems, on account of their high durability in artificial leather materials, are used as a cover layer material or bulk material in order to produce long-lasting products having a thickness equivalent to leather or thicker. In principle, it is possible here to coat artificial leather with a thin layer of a solvent polyurethane system or dispersion polyurethane system and to choose the textile thickness accordingly so that an artificial leather having a thickness corresponding to leather is created, but such structures, because of the usually only thin coating, are not very robust in use. For this reason, polyurethane artificial leathers are often manufactured in such a way that at least one of the textile coating layers consists of a relatively thick, low-solvent or solvent-free reactive polyurethane system.

As an alternative to polyurethane artificial leathers, PVC-based artificial leathers are also used in large amounts on account of their significantly lower price compared to leather and polyurethane artificial leathers. However, the problem with these is that PVC needs to contain plasticizers for processing, the use of which has for many years been the subject of public debate and is viewed increasingly critically. The use of plasticizers has accordingly been increasingly restricted in recent years, for example by REACH regulations or the GADSL list of automobile manufacturers.

Another problem with plasticizers is that they are not firmly incorporated in the PVC matrix. Over time, plasticizers can therefore migrate out of the polymer matrix, resulting in a change in the flexibility properties of PVC artificial leather. Moreover, PVC artificial leather tends to undergo undesirable discoloration with an accompanying deterioration in mechanical stability, especially when exposed to elevated temperatures for relatively long periods, which can occur for example when an automobile is left in the blazing sun for a long time.

Polyurethanes are therefore generally preferred as a coating system over other PVC plastisols, especially since textiles coated with polyurethanes also have a feel similar to that engendered by touching leather.

Coatings comprising polyurethanes can be produced by solidifying polyurethanes from solution or by producing the polyurethanes directly on a substrate from the isocyanate and polyol precursors. Direct production has a number of advantages here over the use of polyurethanes dissolved in solvents or dispersed in water. For example, the production of defect-free parts or webs using dissolved or dispersed polyurethanes can be difficult, since in a manufacturing process the solvents or the water must be defined and evaporated as swiftly as possible from an economic point of view. Moreover, a considerable amount of energy is required for the evaporation process. When using solvent-based polyurethane systems, solvent residues also often remain in the polyurethane and are still detectable in the finished product and/or can adversely affect the odor of the finished product.

By comparison to the direct production of polyurethanes, in which the processor can tailor the properties through an appropriate choice of polyisocyanates or polyisocyanate prepolymers and polyols, dissolved or dispersed polyurethanes are generally commercially available only with specified polyurethane systems.

Since it is virtually impossible for solvent-based polyurethane systems to undergo rapid drying in thicknesses of >100 μm without bubbles and defects, the use of reactive polyurethane systems has gained the upper hand over dissolved or dispersed polyurethanes, especially for the production of polyurethane layers of such thicknesses.

In the direct production of polyurethane layers, speed of production is a key economic factor. This is increased through the use of additional catalysts. Their profile of requirements is such that reaction at room temperature is still suppressed as far as possible so that the reactive components and any other additives can be mixed thoroughly and the compound brought into the desired shape before “curing”, for example by spreading the reactive compound onto a backing paper in a continuous process to produce artificial leather. On the other hand, the reaction of isocyanates and polyols should however then take place as swiftly as possible at the process temperature.

To meet these requirements, various solutions have in the past previously been proposed:

An established approach is for example the use of blocked polyisocyanate prepolymers in a mixture with a polyamine, which reacts to form a polyurethane urea. Blocked polyisocyanates have the advantage that the reactive mixtures can be left at room temperature for a long time and that processing does not require a special mixing-head system that mixes the reactive components only shortly before processing.

Examples of blocking agents used for the reactive isocyanate groups are oximes or caprolactams, which are cleaved from the blocked polyisocyanate at elevated temperature, releasing the reactive isocyanate group. However, a disadvantage here, besides the sometimes high temperature required for cleaving off the blocking agent, is that the cleaved groups are in some cases classified as toxic and—particularly in thicker products—remain to some degree in the product, where they are visually and functionally troublesome on account of their odor or undesirable tendency to migrate to surfaces.

Another disadvantage of such systems is that their availability is predetermined, which means that the desired product properties can be influenced by a suitable choice of raw materials only to a very small degree. Finally, commercially available blocked polyisocyanate systems usually comprise high-boiling solvents such as methoxypropyl acetate to reduce viscosity, which remain in the end product as residues and have to be removed in an energy-intensive manner.

Systems have also been proposed in which a reactive polyisocyanate prepolymer is reacted with a dihydrazide that is solid at room temperature, such as adipic dihydrazide or sebacic dihydrazide. The corresponding mixtures are relatively unreactive at room temperature, whereas a rapid reaction is achieved at higher temperatures by melting the dihydrazide. However, this system too can be adjusted by the user only within narrow limits in respect of the selection of raw materials and, if the stoichiometry is not kept precisely, an excess of the dihydrazide can result in visible and functionally troublesome surface deposits during later use as a result of migration.

EP 1 059 379 B1 describes a polyurethane system having a comparatively long pot life at room temperature that reacts swiftly at elevated temperatures. The starting raw materials of the polyurethane system described in EP 1 059 379 B1 and thus the final properties of the product can be selected from a broad spectrum of suitable polyisocyanates and polyols. In EP 1 059 379 B1, the use of metal acetylacetonates is decisive for the reactivity profile, the metal catalyst used being chelated by acetylacetone ligands and thereby sterically shielded. Only at elevated temperatures is the acetylacetone cleaved off and the catalyzing metal core exposed. However, it has been found that some of the acetylacetone remains in the finished product as a troublesome and toxic solvent and that the nickel acetylacetonate, which is particularly effective as a catalyst, is classified as carcinogenic.

Another disadvantage with this system is that the reaction at room temperature is not suppressed to such an extent that a long pot life, i.e. processing time, would be possible, which means that mixing-head systems generally still have to be used for processing.

EP 1 927 466 B1 describes a similar system in which a metal acetylacetonate, for example a tin-based catalyst, is used in conjunction with additional acetylacetone in the reaction compound. At room temperature this suppresses the reaction and it is only at higher temperatures that the acetylacetone is vaporized so as to increase the reactivity of the catalyst system. However, the disadvantages of using acetylacetone and the relatively short pot life outlined in relation to EP 1 059 379 B1 are problematic here too.

WO 2013/087682 A1 describes bismuth-containing catalysts for polyurethane systems in which bismuth salts or complexes were reacted with a 1,3-ketoamide in a preceding reaction. The resulting catalysts are oily/liquid, but still result in relatively short processing times at room temperature, which translates into short skin formation times.

Against this background, there is a need for catalyst systems that on the one hand are not catalytically active at room temperature or at “mixing temperatures” of polyurethane-forming mixtures but are on the other hand sufficiently active at process temperatures, especially at temperatures above 80° C., for a very substantially reacted polyurethane to form within short reaction times. The present invention addresses this need.

There is also a need for reactive polyurethane system formulations based on a polyisocyanate or polyisocyanate prepolymer and polyols, with which decorative and flexible surfaces can be produced that can be used in all applications in which artificial leather or leather is already being used today. In such formulations, a metal catalyst that is not classified as toxic should as far as possible be employed and the reactivity should at room temperature be suppressed to an extent such that no complex equipment such as mixing-head systems are required for processing.

The formulations and the use of said formulations should permit the production of a film having at least one polymeric layer, which can optionally also be foamed and which, as the sole film layer or as one of a plurality of film layers, is a component of a decorative material such as a film or artificial leather. By permitting the production of layers having a particular thickness, the formulation should permit the production of decorative films that are agreeable to the touch and that, by virtue of the thickness of the applied layer, also prevent the textile structure from making its presence felt on the surface.

The present invention addresses this need.

### DESCRIPTION OF THE INVENTION

The present invention is based on the surprising finding that these properties can be imparted by a catalyst system that comprises a metal-based catalyst based on a salt or an organometallic compound and a diketo compound having a melting point of 15° C. Mixtures of these catalyst systems with polyisocyanates and polyols show relatively stable viscosity at room temperature and can be activated by increasing the temperature, with the result that tacky polyurethane layers no longer form, for example at 150° C. within 120 seconds.

Accordingly, the present invention relates in a first aspect to a reactive compound for producing a polyurethane layer, said compound comprising
an isocyanate component composed of at least one polyfunctional isocyanate, an oligomer of a polyfunctional isocyanate or an isocyanate prepolymer,
a polyol component composed of at least one polyol, and
a catalyst system comprising a metal-based catalyst based on a salt or on an organometallic compound and a diketo compound having a melting point of ≥15° C.

The “metal-based catalyst” in the reactive compound is a substance that, when added to a mixture of polyisocyanates and polyols, is able to accelerate the reaction to form a polyurethane (by comparison with a reaction without the catalyst).

The “catalyst system” is conveniently produced by intimately mixing the metal-based catalyst with the diketo compound, it being possible to add a solvent. In place of a solvent, it is also possible to use short-chain esters of mono-, di-, and tricarboxylic acids that are liquid at room temperature with aliphatic monofunctional polyols having a molar mass of less than 1000 g/mol. It is assumed that the diketo compound binds here to the metal of the metal-based catalyst, wherein it is possible to displace the anions of the salt.

The terms “polyfunctional isocyanate” and “polyisocyanates” are used synonymously in the context of this description.

The particular advantage of the reactive compounds described herein over the prior art outlined above is that the mixture has a particularly long processing time (pot life) at room temperature without the activity of the catalyst being significantly affected at elevated processing/process temperatures.

Diketo compounds used with preference in the reactive compound are ones having a melting point of ≥25° C. and more preferably ≥30° C. Particular preference is given to diketo compounds in the form of 1,3-diketo compounds. The carbon atom positioned between the two CO groups may be substituted or unsubstituted (in this case it is present in the form of a CH₂ group). Very particular preference is given to a structure R¹—CO—CH₂—CO—R², where R¹ and R² are preferably independently selected from aliphatic and aromatic radicals, which may optionally be substituted. A preferred aliphatic radical in this context is an alkyl or alkenyl radical, which may be linear, branched or cyclic. A preferred aromatic radical is an aryl radical and especially a phenyl radical, or a heteroaryl radical, especially a pyridyl radical.

Suitable substituents that may be present in the respective radicals are especially halogens that are non-reactive towards the metal center in the catalyst, especially in the form of fluorine atoms, and nonpolar substituents such as methoxy groups, aryl groups (when the primary radical is an aliphatic radical) or alkyl or alkenyl radicals (when the primary radical is an aromatic radical). Other substituents are however also conceivable.

Examples of possible substituents of the diketo compound, for example as radical R¹ and R² in the formula shown above are alkyl and alkenyl groups having 1 to 18 carbon atoms, cycloalkyl groups, cycloalkenyl groups and cycloalkyl alkylene groups, and alkylcycloalkyl groups having 5 to 18 carbon atoms, and non-fused aryl groups (including aralkyl and alkylaryl) having 6 to 18 carbon atoms, for example methyl, ethyl, propyl, isopropyl, isobutyl, n-butyl, s-butyl, t-butyl, 1-pentyl, 3-pentyl, 1-hexyl, 1-heptyl, 3-heptyl, 1-octyl, 2,4,4-trimethylpentyl, t-octyl, nonyl, decyl, tridecyl, pentadecyl, heptadec-8-en-1-yl, n-octadecyl, allyl, methallyl, 2-hexenyl, 1-methylcyclopentyl, cyclohexyl, cyclohexanepropyl, phenyl, m-tolyl, p-ethylphenyl, t-butylphenyl, benzyl, phenylpropyl, and nonylbenzyl.

It is possible for one of the ketone functionalities of the diketo compounds to be present in a ring, as is the case for example in 2-acetyl-1-tetralone, 1-palmitoyl-2-tetralone, 2-stearoyl-1-tetralone, 2-benzoyl-1-tetralone, 2-acetyl-cyclohexanone, and 2-benzoylcyclohexanone. In one embodiment, the diketo compound comprises one of these substances.

Examples of preferred diketo compounds in which both keto functionalities are present outside a ring include benzoyl-p-chlorobenzoylmethane, bis(4-methyl-benzoyl)methane, bis(2-hydroxybenzoyl)methane, benzoylacetylmethane, tribenzoylmethane, diacetylbenzoylmethane, stearoylbenzoylmethane, palmitoylbenzoylmethane, lauroylbenzoylmethane, dibenzoylmethane, 4-methoxybenzoylbenzoylmethane, bis(4-methoxybenzoyl)methane, bis(4-chlorobenzoyl)methane, bis(3,4-methylenedioxybenzoyl)methane, benzoylacetyloctylmethane, benzoylacetylphenylmethane, stearoyl-4-methoxybenzoylmethane, bis(4-t-butylbenzoyl)methane, benzoylacetylethylmethane, benzoyltrifluoroacetylmethane, diacetylmethane, butanoylacetylmethane, heptanoylacetylmethane, triacetylmethane, stearoylacetylmethane, palmitoylacetylmethane, lauroylacetylmethane, benzoylformylmethane, acetylformylmethylmethane, benzoylphenylacetylmethane, bis(cyclohexanecarbonyl)methane, and dipivaloylmethane. The diketo compound may also be included in the catalyst system in the form of a mixture of two or more of the abovementioned diketo compounds.

The diketo compound contains preferably 5 to 30 carbon atoms.

Very particularly preferred diketo compounds for use in the reactive compounds according to the invention are stearoylbenzoylmethane (Tm 56-59° C.), palmitoylbenzoylmethane, 1-phenylbutane-1,3-dione (Tm 54-56° C.), dibenzoylmethane (Tm 77-79° C.), 1,3-bis(4-methoxyphenyl)propane-1,3-dione (Tm 108-115° C.), 1,3-di-(2-pyridyl)-propane-1,3-dione (Tm 104-109° C.), 5,5′-dimethylcyclohexane-1-3-dione (Tm 146-148° C.), cyclohexane-1,3-dione (101-105° C.) or mixtures of said diketo compounds, especially in the form of a mixture of stearoylbenzoylmethane and palmitoylbenzoylmethane (Tm 55° C.), as obtainable under the trade name Rhodiastab 55P from Solvay.

Other diketo compounds that can be used are listed in U.S. Pat. No. 8,859,654 B2 in column 2, rows 16-34, which are hereby incorporated by reference into this application, provided they have a melting point of 15° C.

The metal present in the metal-based catalyst is a metal that is capable of, and suitable for, catalyzing the reaction of isocyanates and alcohols, the catalysis occurring in most cases via attachment of the metal to the oxygen atom of the isocyanate, thereby reducing the electron density at the carbon atom of the isocyanate. Metals that favor such an activation and that are accordingly preferred as the metal of the metal-based catalyst, are selected from the following group of metals: tin, zinc, bismuth, potassium, cobalt, manganese, titanium, iron, zirconium and nickel. Very particularly preferred metals are zinc and/or bismuth (being sufficiently active and non-toxic metals), of which bismuth is particularly preferred.

In addition, the use of metals or metal compounds of lead or mercury is possible, but the high toxicity of these metals means that their use in the reactive compounds according to the invention should be avoided. Preference in the context of the invention described herein is accordingly given to reactive compounds that do not contain added lead or mercury.

The recited metals may be included in the catalyst system in the form of a metal salt or organometallic compound, preference being given to metal salts, since they are usually more stable. Preferred metal salts for use in the catalyst system according to the invention are organic metal salts, selected in particular from the group comprising metal acetylacetonates, metal ethylhexanoates, metal octoates, metal naphthenates, metal acetates, metal neodecanoates, metal malonates, and metal carboxylates, and inorganic metal salts, selected in particular from the group comprising metal nitrates, metal pyrophosphates, and metal halides. On account of its very good reactivity at elevated temperature and because it is not classified as toxic, very particular preference is given to bismuth carboxylate or bismuth neodecanoate in the reactive compounds according to the invention.

The amount of the catalyst system is not subject to any relevant restrictions and can generally be adjusted by those skilled in the art so that on the one hand the desired reactivity is established but on the other hand the amount of the catalyst system is as low as possible. Preference is given here to a content of the catalyst system in the reactive compound in the range from 0.01% to 1% by weight and preferably from 0.02% to 0.5% by weight. Any solvent added for the formation of the catalyst system or of an added low-molecular-weight carboxylic ester that is liquid at room temperature does not need to be taken into account here, since this is not active as such in the catalysis of polyurethane formation.

The ratio of metal-based catalyst to diketo compound is preferably in the range from about 1:2 to 1:20, and more preferably in the range from about 1:4 to 1:15.

The isocyanate component is not subject to any relevant restrictions in the reactive compounds according to the invention, with the proviso that the isocyanates in combination with the polyols in the reactive compound are not so reactive that a significant reaction takes place even under ambient conditions (room temperature) without a catalyst. Polyfunctional isocyanates that can be used in the isocyanate component are aliphatic and/or aromatic polyisocyanates, selected in particular from the group comprising 2,2′-, 2,4′- and 4,4′-methylenediphenyl isocyanate (MDI), toluene 2,4- and 2,6-diisocyanate (TDI), naphthylene-1,5-diisocyanate, hexamethylene 1,6-diisocyanate (HMDI), isophorone diisocyanate (IPDI), cyclohexane 1,4-diisocyanate, bis(isocyanatomethyl)cyclohexane, and dicyclohexylmethane 4,4′-diisocyanate, an oligomer or polymer of such a polyfunctional isocyanate, an isocyanate prepolymer obtained from the reaction of such a polyfunctional isocyanate with polyol, or mixtures thereof.

Oligomers of polyfunctional isocyanates include for example isocyanurates, uretdiones, and biurets. An example of a polyisocyanate polymer that can be used is poly-MDI.

It is preferable when an isocyanate prepolymer is used at least in part as the isocyanate component. An isocyanate prepolymer is understood here as meaning the reaction product of a polyisocyanate with a polyol, the polyisocyanate preferably being used in a ratio to the polyol such that the NCO/OH ratio is at least 2. This means that, in such an isocyanate prepolymer, all OH groups will on average have been converted into —O—CO—NH—R—NCO groups (where “R” denotes the structure of a polyisocyanate without isocyanate groups). It is also preferable when the polyol used to produce the isocyanate prepolymer is a polyol having an average functionality in the range from 1.85 to 2.5, especially 1.9 to 2.2, and very particularly preferably of about 2.0.

The isocyanate prepolymer also preferably has a content of isocyanate groups (determined as the proportion by weight) of between about 2 and 20% and especially between about 4 and 13%. These isocyanate prepolymers can in addition to urethane groups also contain other functional groups such as ether, thioether, ester, and carbonate groups, which can be incorporated into the isocyanate prepolymer via the polyol, or urea groups.

Also possible but not preferred for the purposes of the invention is the use of isocyanate-containing compounds in which the isocyanate group is temporarily chemically blocked and can be reactivated again by heating and cleaving off a blocking group. Examples of blocking agents used here are ketoximes such as butanone oxime or acetone oxime, or caprolactam. Mixtures of the abovementioned constituents of the isocyanate component may likewise be used.

The polyol component is also not subject to any relevant restrictions in the reactive compounds according to the invention, but here too it must be ensured that the polyols do not form a relative mixture with the isocyanates such that a significant reaction takes place even under ambient conditions (room temperature) without a catalyst. Suitable polyols for use in the reactive compounds according to the invention have a molecular weight in the range from 62 to 20 000, especially 250 to 10 000 g/mol, and more preferably in the range from 2000 to 8000 g/mol. In the case of polymeric polyols, the molecular weight refers here to the average molecular weight Mw and is to be determined by GPC with the inclusion of suitable standards (for example polystyrene).

Preference in the reactive compounds according to the invention is given in particular to aliphatic polyols, which are preferably bifunctional or higher. The term “aliphatic” is to be understood here as meaning that the polyol does not contain any aromatic components, whereas functional groups such as ether, ester, carbonate, and urea groups may be present in the polyol. In view of the specified preferred molecular weights, preference is therefore given to polymer-based polyols and especially to polyols selected from the group comprising polyester polyols, polyether polyols, polythioether polyols, polycarbonate polyols, polyols having a plurality of the functional groups present in the abovementioned polymers, aliphatic polyacetals containing hydroxyl groups, and aliphatic polycarbonates containing hydroxyl groups. It is very particularly preferable when the polyol component comprises at least one polyether polyol and it is most preferable when the polyol component comprises exclusively polyether polyols.

In order to impart appropriate resistance to external stresses, the reactive compound according to the invention preferably comprises a proportion of higher-functional and especially trifunctional polyols. It is even more preferable that the reactive compound does not contain any polyols higher than trifunctional. When the reactive compound comprises trifunctional and difunctional polyol in the polyol component or is formed from trifunctional and difunctional polyol, it is preferable that the trifunctional polyol accounts for a proportion of at least 50% by weight, and more preferably in the range from 65% to 90% by weight, of the polyol component. It is very particularly preferable when polyether polyols are used as the trifunctional and difunctional polyol.

The polyisocyanate component and the polyol component are expediently used in a ratio in which isocyanate groups are present in excess over OH groups, especially when the polyol component comprises polyols having a functionality of >2. The excess of isocyanate groups means that reaction of all the OH groups in the reactive compound is then as far as possible achieved; excess NCO groups remain, but these can subsequently react with atmospheric moisture and thus be broken down to —NH₂ groups.

In addition to the polyols, other compounds that react with isocyanates and that contain reactive hydrogen atoms may in the reactive compound according to the invention be used in place of a proportion of the polyols in order to modify the properties of the reacted system. Such compounds contain for example two or more reactive groups present in the form of OH groups, SH groups, NH groups, NH₂ groups or acidic CH groups, for example in beta-diketo compounds.

In addition to the components described above, the reactive compound according to the invention may comprise one or more additives conventionally used for the production of polyurethane layers and polyurethane artificial leathers, for example to optimize particular properties or to increase the reactivity still further.

An example of an additive to increase reactivity is a co-catalyst, for example in the form of a base that stabilizes a proton donated by polyols or other compounds with acidic H atoms during polyurethane formation. Examples of correspondingly suitable bases are 1,8-diazabicyclo[5.4.0]undec-7-ene (DBU), 1,4-diazabicyclo[2.2.2]octane (DABCO), dimethylaminoethanol, etc. It is also possible to add liquid additives that retard the reactivity of the metal catalyst, for example acetylacetone or 2-ethylhexanoic acid, but this is not necessary for the purposes of the invention. Such liquid additives are preferably not present in the reactive compounds according to the invention, since acetylacetone-containing reactive compounds have a pungent odor after conversion into polyurethanes and 2-ethylhexanoic acid is classified as teratogenic and, because of its boiling point of 228° C., remains in the product during polyurethane formation.

Additives used in polyurethane layers and polyurethane artificial leathers are in particular anti-aging agents, flame retardants, fillers, preferably in the form of chalk (CaCO₃) or cellulose derivatives, pigments, leveling aids, deaeration aids, processing aids, rheological aids, leveling aids, foaming aids, solvents, carboxylic esters, and crosslinkers. The reactive compound according to the invention therefore preferably comprises one or more such additives.

Suitable flame retardants are for example aluminum trihydrate or organic phosphinates such as aluminum diethylphosphinate. Suitable leveling agents are for example silicone oils.

In the reactive compounds according to the invention, the solvent content should be as low as possible and, when they do contain solvent, use should wherever possible be made of solvents that can easily be evaporated during subsequent processing. This permits the production of end products having a very low VOC (volatile organic compound) content.

For processing, the reactive compound according to the invention is preferably adjusted to a suitable viscosity, preferably in the range from 1 Pa·s to 120 Pa·s, especially from 5 Pa·s to 15 Pa·s; this viscosity may be determined, for example in the compound in front of a coating bar gap via which the compound is applied to a substrate, in accordance with ISO 2555:2018.

In a further aspect, the present invention relates to a polyurethane layer obtainable by applying a reactive compound, as described above, to a substrate and reacting the isocyanate component with the polyol component to form a polyurethane. Because the catalyst system used for the reaction comprises high-boiling diketo compounds, these are present in the polyurethane layer after the reaction and can be detected by extraction and detection, for example by GC or HPLC-MS.

With the reactive compound according to the invention it is possible in particular to produce thick layers too, for example in an artificial leather or a film composite, consequently it is preferable for the polyurethane layer to have a thickness of at least 100 μm, especially in the range from 150 to 800 μm, and more preferably in the range from 200 to 350 μm.

In order to impart to a polyurethane layer an appearance that the normal user associates with leather, for example, it is advantageous when the polyurethane layer has on one side a visually recognizable structuring. Structuring in the form of embossing that imitates the skin side of leather is preferred here.

It is of particular advantage in individual cases when the polyurethane layer is provided with a lacquer layer. The purpose of this is, for example, to improve the surface properties, especially the wear resistance. In addition, a lacquer layer provides a means of controlling the optical properties of the surface, for example the gloss, as desired. A lacquer layer is applied to the surface of the polyurethane layer in a manner known in the art while this is freely accessible from above.

In one embodiment, the polyurethane layer is compact and has no cavities. In another embodiment, the cover layer is foamed and has isolated cavities. In another embodiment, the cover layer is foamed and has interconnected cavities.

The polyurethane layer may be level/planar or in the form of an object onto or into which it is applied or incorporated, for example by spraying, casting, pouring into a mold, pouring over a mold, immersion, printing, or spraying.

In a further aspect, the present invention relates to a method for producing a polyurethane layer, as described above, wherein
a reactive compound as described above is applied to a substrate,
the reactive compound is heated to react the isocyanate and polyol components with the formation of the polyurethane layer, preferably to a temperature above the melting temperature of the diketo compound present in the reactive compound,
and the substrate is then optionally removed from the polyurethane layer.

To produce a structured surface in the polyurethane layer, the substrate can have a structuring that corresponds to the negative of the structuring to be created on the polyurethane layer. Such a method is also referred to in the prior art as reverse coating.

Thick polyurethane layers that form the cover layer of an artificial leather (i.e. the layer forming the visible side, which may optionally in turn be coated with a lacquer layer) are particularly advantageous in the production of artificial leathers, since the high layer thickness means that a textile structure of a backing layer does not press through to the surface and the overall composite has a pleasant feel/is agreeable to the touch.

In a further aspect, the present invention relates therefore to a composite structure that comprises a polyurethane layer as described above, a backing layer, especially a textile backing layer or a backing layer made of PVC, polyolefin, thermoplastic polyurethane or a polyurethane foam, and optionally an adhesive layer arranged between said layers and/or a lacquer layer applied to the side of the polyurethane layer opposite the backing layer.

In a preferred embodiment, the polyurethane layer in the composite structure is composed essentially (i.e. to an extent of at least 98% by weight, preferably at least 99% by weight, and even more preferably at least 99.5% by weight) of aliphatic polyols and polyisocyanates. Such polyurethanes have the advantage of high resistance to yellowing and aging.

In another preferred embodiment, the polyurethane layer in the composite structure is dark colored or black, or the polyurethane layer does not form the uppermost layer of the composite structure (a lacquer layer does not count as the uppermost layer here). In this case, it is preferable when aromatic polyisocyanates were additionally used for the formation of the polyurethane layer or even used exclusively.

In a further aspect, the present invention relates to the use of a mixture of a metal-based catalyst based on a salt or an organometallic compound and a diketo compound having a melting point of 15° C., preferably as described above, as a catalyst system for the reaction of polyols and polyisocyanates.

For the specified polyurethane layers, methods, composite structures and uses, features described as preferred in connection with the reactive compound are likewise considered disclosed and preferred, provided they are not in obvious contradiction to one another.

When processed in the production of artificial leathers or films having a surface that imitates the appearance of leather, the reactive compounds according to the invention achieve the following additional advantages, to which additional reference should be made in this regard:

The composite structures comprising at least one polyurethane layer obtained from a reactive compound according to the invention can be produced in the same thickness as leathers that are already in use today, for example in automobile interiors. To produce the necessary thicknesses, one or more layers may optionally be used.

A polyurethane layer or a composite structure having such a layer that is formed from the reactive compound according to the invention may also be produced in a continuous process such as a continuous coating process (direct or transfer coating).

By choosing suitable polyols, polyisocyanates, and other ingredients to be included in the reactive compound, the discoloration after prolonged exposure to heat or UV radiation of a polyurethane layer produced therefrom can be kept so low that even light-colored artificial leather based on the invention can be used without problem in the instrument panels of vehicles. In addition, the manufactured products are able to remain dimensionally stable even after prolonged exposure to heat (for example climatic storage at temperatures of up to 105° C. for 26 weeks).

The polyurethane layers according to the invention may in particular embodiments also be wear-resistant and flexible to a degree sufficient to permit use in the customary seating applications in the furniture and automotive sectors and sufficient to pass the qualification tests (robot test, entry-and-exit test) necessary for this purpose.

The polyurethane layers according to the invention can also be flexible across a wide temperature range (from −20° C.), thus minimizing the risk of artificial leather cracking due to brittleness when the seat is cold.

The invention is illustrated in more detail below with reference to a few examples, which should not however be regarded as restricting the scope of protection of the application in any way.

### Examples

### Production of the Catalyst Mixtures:

For the production of the catalyst systems according to the invention, the mixtures of metal salts and diketones used in Table 1 were prepared as follows: In mixtures comprising Rhodiastab 55 P (mixture of stearoylbenzoylmethane and palmitoylbenzoylmethane, Tm=56° C.), the specified amount of toluene was added to dissolve this compound and the mixture was stirred at room temperature until a homogeneous solution had formed. No solvent was added to mixtures comprising acetylacetonate. Metal salt catalysts without diketone additives were used as such.

The following substances were used as metal salts:

Nickel acetylacetonate (Sigma-Aldrich), bismuth neodecanoate (Borchikat 315 EU, Borchers), zinc neodecanoate (Reaxis C616, Reaxis), bismuth carboxylate (Reaxis C716, Reaxis), tin dioctylbis(2,4-pentanedionato-KO2-KO4) (Reaxis C2013, Reaxis), bismuth/zinc neodecanoate mixture
(Bicat 8, Shepherd), zinc salt of a C12-C14 fatty acid (Kosmos 54, Evonik) Acetylacetone (Sigma-Aldrich) and Rhodiastab 55 P (Rhodia/Solvay) were used as diketone additives.

TABLE 1

| | Toluene | | | Diketo | |
|---|---|---|---|---|---|
| Designation | [proportion] | Metal salt | Proportion | compound | Proportion |
| V1 | 10 | Nickel | 0.6 | — | |
| | | acetylacetonate | | | |
| V2 | — | Bismuth | 0.5 | — | |
| | | neodecanoate | | | |
| V3 | — | Zinc | 0.5 | — | |
| | | neodecanoate | | | |
| V4 | — | Bismuth | 0.5 | — | |
| | | carboxylate | | | |
| V5 | — | Tin | 0.5 | — | |
| | | dioctylbis(2,4- | | | |
| | | pentanedionato- | | | |
| | | KO2—KO4) | | | |
| V6 | — | Bismuth/zinc | 0.5 | — | |
| | | neodecanoate | | | |
| | | mixture | | | |
| V7 | — | Bismuth | 0.2 | Acetylacetone | 17 |
| | | neodecanoate | | | |
| V8 | — | Bismuth | 0.4 | Acetylacetone | 17 |
| | | neodecanoate | | | |
| V9 | — | Bismuth | 0.4 | Acetylacetone | 19 |
| | | neodecanoate | | | |
| V10 | — | Bismuth | 0.6 | Acetylacetone | 17 |
| | | neodecanoate | | | |
| V11 | — | Bismuth | 0.6 | Acetylacetone | 28 |
| | | neodecanoate | | | |
| V12 | — | Bismuth | 0.8 | Acetylacetone | 17 |
| | | neodecanoate | | | |
| V13 | — | Bismuth | 0.2 | — | |
| | | neodecanoate | | | |
| K1 | 5 | Bismuth | 0.2 | Rhodiastab | 0.5 |
| | | neodecanoate | | 55 P | |
| K2 | 10 | Bismuth | 0.2 | Rhodiastab | 1 |
| | | neodecanoate | | 55 P | |
| K3 | 15 | Bismuth | 0.2 | Rhodiastab | 1.5 |
| | | neodecanoate | | 55 P | |
| K4 | 20 | Bismuth | 0.2 | Rhodiastab | 2 |
| | | neodecanoate | | 55 P | |
| K5 | 25 | Bismuth | 0.2 | Rhodiastab | 2.5 |
| | | neodecanoate | | 55 P | |
| V14 | — | Bismuth | 0.4 | — | |
| | | neodecanoate | | | |
| K6 | 10 | Bismuth | 0.4 | Rhodiastab | 1 |
| | | neodecanoate | | 55 P | |
| K7 | 20 | Bismuth | 0.4 | Rhodiastab | 2 |
| | | neodecanoate | | 55 P | |
| K8 | 30 | Bismuth | 0.4 | Rhodiastab | 3 |
| | | neodecanoate | | 55 P | |
| K9 | 40 | Bismuth | 0.4 | Rhodiastab | 4 |
| | | neodecanoate | | 55 P | |
| K10 | 50 | Bismuth | 0.4 | Rhodiastab | 5 |
| | | neodecanoate | | 55 P | |
| V15 | — | Bismuth | 0.6 | — | |
| | | neodecanoate | | | |
| K11 | 15 | Bismuth | 0.6 | Rhodiastab | 1.5 |
| | | neodecanoate | | 55 P | |
| K12 | 30 | Bismuth | 0.6 | Rhodiastab | 3 |
| | | neodecanoate | | 55 P | |
| K13 | 45 | Bismuth | 0.6 | Rhodiastab | 4.5 |
| | | neodecanoate | | 55 P | |
| K14 | 60 | Bismuth | 0.6 | Rhodiastab | 6 |
| | | neodecanoate | | 55 P | |
| K15 | 75 | Bismuth | 0.6 | Rhodiastab | 7.5 |
| | | neodecanoate | | 55 P | |
| K16 | 80 | Bismuth | 0.8 | Rhodiastab | 8 |
| | | neodecanoate | | 55 P | |
| K17 | 80 | Bismuth | 0.8 | Rhodiastab | 8 |
| | | neodecanoate | | 55 P | |
| K18 | 80 | Bismuth | 0.8 | Rhodiastab | 8 |
| | | neodecanoate | | 55 P | |
| K19 | 80 | Bismuth | 0.8 | Rhodiastab | 8 |
| | | neodecanoate | | 55 P | |

Use of the catalysts for the production of polyurethanes:

The catalyst systems thereby obtained were used to produce homogeneous mixtures with polyisocyanate prepolymers and polyols according to the following recipe:
770 g trifunctional polyether polyol (OH value 20.2; viscosity approx. 5000 mPa·s)
140 g difunctional polyether polyol (OH value 28; viscosity approx. 1000 mPa·s)
281 g diisocyanate prepolymer based on MDI and a polyether (isocyanate content 6.8%, viscosity approx. 5500 mPa·s)
7 g leveling aid (Levacast Fluid SN, Lanxess)
235 g aluminum trihydrate powder (flame retardant, average particle diameter=13-20 μm)
45 g organic phosphinate (flame retardant, average particle diameter=10 μm)
295 g chalk powder (filler, average particle diameter=2 μm)

The amount of catalyst used corresponds to the sum of the numerical values in the respective line in Table 1. The isocyanate component was used in excess (NCO/OH ratio 1.29).

For the mixtures thereby produced, the viscosity was determined at t=0 and at t=30 and 60 min using a Brookfield viscometer in accordance with ISO 2555:2018. During this time the mixture was stored at room temperature (25° C.).

To determine the reactivity of the catalyst, the mixture was applied to coated paper using a doctor blade and a gap distance of 300 μm and then heated to 150° C. for 120 seconds, affording a film having a weight per unit area of about 300 g/m². The curing of the film was then assessed as either “tacky” or “dry”. The results of the viscosity determinations and curing are shown in Table 2 below:

TABLE 2

| | | Viscosity of | Viscosity of | Viscosity of | |
|---|---|---|---|---|---|
| | | compound at | compound at | compound at | Character of |
| | | 0 min | 30 min | 60 min | the film after |
| Mixture | Catalyst | [mPa · s] | [mPa · s] | [mPa · s] | 2 min/150° C. |
| 1 | V1 | 10000 | 41000 | 72000 | dry |
| 2 | V2 | 12000 | not | not | dry |
| | | | measurable | measurable | |
| 3 | V3 | 11000 | not | not | tacky |
| | | | measurable | measurable | |
| 4 | V4 | 12000 | not | not | dry |
| | | | measurable | measurable | |
| 5 | V5 | 13000 | not | not | dry |
| | | | measurable | measurable | |
| 6 | V6 | 12000 | not | not | dry |
| | | | measurable | measurable | |
| 7 | V7 | 10000 | 12000 | 15000 | dry |
| 8 | V8 | 10000 | 46000 | 120000 | dry |
| 9 | V9 | 12000 | 30000 | 58000 | dry |
| 10 | V10 | 12000 | 90000 | not | dry |
| | | | | measurable | |
| 11 | V11 | 10000 | 53000 | 100000 | dry |
| 12 | V12 | 13800 | not | not | dry |
| | | | measurable | measurable | |
| 13 | V13 | 12000 | not | not | dry |
| | | | measurable | measurable | |
| 14 | K1 | 10000 | 19000 | 42000 | dry |
| 15 | K2 | 14000 | 18000 | 28000 | dry |
| 16 | K3 | 14000 | 16000 | 22000 | dry |
| 17 | K4 | 11000 | 15000 | 23000 | dry |
| 18 | K5 | 10000 | 13000 | 23000 | dry |
| 19 | V14 | 12000 | not | not | dry |
| | | | measurable | measurable | |
| 20 | K6 | 9000 | 30000 | 47000 | dry |
| 21 | K7 | 12000 | 17000 | 27000 | dry |
| 22 | K8 | 11000 | 15000 | 20000 | dry |
| 23 | K9 | 9000 | 12000 | 17000 | dry |
| 24 | K10 | 8000 | 15000 | 20000 | dry |
| 25 | V15 | 12000 | not | not | dry |
| | | | measurable | measurable | |
| 26 | K11 | 11000 | 25000 | 52000 | dry |
| 27 | K12 | 10000 | 16000 | 22000 | dry |
| 28 | K13 | 9000 | 13000 | 19000 | dry |
| 29 | K14 | 7000 | 10000 | 15000 | dry |
| 30 | K15 | 9000 | 11000 | 15000 | dry |
| 31 | K16 | 7000 | 8000 | 8000 | tacky |
| 32 | K17 | 6000 | 8000 | 12000 | dry |
| 33 | K18 | 7000 | 8000 | 13000 | tacky |
| 34 | K19 | 8000 | 10000 | 14000 | dry |

The comparative mixtures 1-6, 13, 19, and 25 show that (with the exception of the zinc-based catalyst V3, the catalytic activity of which is insufficient here) a dry film can be produced from the reactive compound using the catalysts tested. In all cases the possible processing time is however very short, since the viscosity increases so substantially within 30 min that it is no longer possible to process the reactive compounds. Only when using the toxicologically problematic catalyst V1 (example 1) is a compound that still has a processable viscosity obtained after 30 min, but here too there is a very substantial rise compared to the initial viscosity. In all cases, said compounds are barely processable without the use of technically complex mixing-head systems.

Comparative mixtures 7 to 12 show that the processing time can be significantly prolonged by using the liquid 1,3-diketo compound acetylacetone in combination with the reactive catalyst bismuth neodecanoate. The reason for this is that the acetylacetone complexes the metal catalyst and releases it fully for catalysis again only through evaporation. An application of this principle is described for example also in EP 1 927 466 B1.

However, comparative mixtures 7 to 12 too show a relatively marked rise in viscosity, especially when the amounts of catalyst are increased, which means that processing without mixing-head systems is difficult here too. Moreover, for a worthwhile effect it is necessary to use relatively large amounts of acetylacetone, which, because of the high boiling point of acetylacetone of 140° C., results at 150° C. in some of this highly odoriferous substance, which is classified as toxic, remaining in the end product.

Mixtures 14 to 18, 20 to 24, and 26 to 30 demonstrate the effectiveness of the solid diketo compound (in this case a mixture of stearoylbenzoylmethane and palmitoylbenzoylmethane) in the compound with bismuth neodecanoate as catalyst by way of example. The diketo compound employed does not adversely affect the reactivity of the compound in any of the amounts used and in all cases a dry film can be produced at 150° C. in 2 min.

Furthermore, the addition of an appropriate amount of diketone allows the proportion of catalyst to be greatly increased without the viscosities or pot lives of the compound increasing as a result (see mixtures 16, 22 and 28). This shows that the amount of catalyst can be readily increased for faster processing without this adversely affecting the processing times/pot lives during production and storage of the compound.

From examples 14 to 30 it is also clear that for the longest possible processing time there is an optimum employed amount of 1,3-diketo compound and that increasing this amount further in relation to the catalyst used brings no further beneficial effect. Thus, the viscosity of reactive compounds 17 and 18 after 60 min is no lower than that of compound 16, which has a lower content of the diketo compound.

It is assumed that the good effectiveness of the 1,3-diketo compounds that are solid at room temperature is favored by the fact that the complexation of the metal core of the catalyst by the 1,3-diketo compound is very stable: firstly, because this compound is unable to evaporate at room temperature and, secondly, through the formation of stable micelle-like structures that shield the metal atom very effectively, with the nonpolar aliphatic ends pointing outwards.

This also explains the particularly good interaction shown here between the aliphatic radical in bismuth neodecanoate and the long aliphatic chain in stearoylbenzoylmethane or palmitoylbenzoylmethane. Only at higher temperatures is this interaction eliminated and the metal core “released”.

From mixtures 31 to 34 it is clear that, even when using other metal catalysts containing diketo compounds that are solid at room temperature, long processing times are achieved at room temperature and the viscosities of the compounds are still low even after 60 min. Aside from the two mixtures 31 and 33 comprising zinc catalysts, which are insufficiently reactive even without addition of diketo compound, dry films are produced at 150° C. in 2 min here too.

1.-18. (canceled)

19. A reactive compound for producing a polyurethane layer, said compound comprising
an isocyanate component composed of at least one polyfunctional isocyanate, an oligomer of a polyfunctional isocyanate or an isocyanate prepolymer,
a polyol component composed of at least one polyol, and
a catalyst system comprising a metal-based catalyst based on a salt or on an organometallic compound and a diketo compound having a melting point of 15° C.

20. The reactive compound as claimed in claim 18, wherein the diketo compound is in the form of a 1,3-diketo compound, in particular having a structure R1-CO—CH2-CO—R2, where R1 and R2 are independently selected from aliphatic and aromatic radicals, from linear, branched or cyclic alkyl or alkenyl radicals and optionally substituted aryl or heteroaryl radicals.

21. The reactive compound as claimed in claim 20, wherein the diketo compound is selected from stearoylbenzoylmethane, palmitoylbenzoylmethane, 1-phenylbutane-1,3-dione, dibenzoylmethane, 1,3-bis(4-methoxyphenyl)propane-1,3-dione, 1,3-di-(2-pyridyl)-propane-1,3-dione, 5,5′-dimethylcyclohexane-1-3-dione, cyclohexane-1,3-dione or mixtures of said diketo compounds.

22. The reactive compound of claim 18, wherein the metal-based catalyst is a metal selected from the group comprising tin, zinc, bismuth, potassium, cobalt, manganese, titanium, iron, zirconium and nickel.

23. The reactive compound of claim 18, wherein the catalyst system comprises an organic metal salt selected from the group comprising metal acetylacetonates, metal ethyl hexanoates, metal octoates, metal naphthenates, metal acetates, metal neodecanoates, metal malonates, and metal carboxylates and/or an inorganic metal salt selected from the group comprising metal nitrates, metal pyrophosphates, and metal halides.

24. The reactive compound of claim 18, wherein the reactive compound comprises the catalyst system in a content of from 0.01% to 1% by weight.

25. The reactive compound of claim 18, wherein the reactive compound comprises as the isocyanate component an aliphatic or aromatic polyisocyanate, selected from the group comprising 2,2′-, 2,4′-, and 4,4′-methylenediphenyl isocyanate, toluene 2,4- and 2,6-diisocyanate, naphthylene-1,5-diisocyanate, hexamethylene 1,6-diisocyanate, isophorone diisocyanate, cyclohexane 1,4-diisocyanate, bis(isocyanatomethyl)cyclohexane, and dicyclohexylmethane 4,4′-diisocyanate, an oligomer or polymer of such a polyfunctional isocyanate, an isocyanate prepolymer obtained from the reaction of such a polyfunctional isocyanate with polyol, or mixtures thereof.

26. The reactive compound of claim 18, wherein the reactive compound comprises as the polyol component a polyol having a molecular weight Mw in the range from 62 to 20 000.

27. The reactive compound of claim 18, wherein the reactive compound comprises as the polyol component a polyol selected from the group comprising polyester polyols, polyether polyols, polythioether polyols, polycarbonate polyols, polyols having a plurality of the functional groups present in the abovementioned polymers, aliphatic polyacetals containing hydroxyl groups, and aliphatic polycarbonates containing hydroxyl groups.

28. The reactive compound of claim 18, wherein the reactive compound comprises as the polyol component a mixture of trifunctional and difunctional polyol, wherein the trifunctional polyol accounts for a proportion of at least 50% by weight.

29. The reactive compound of claim 18, wherein the reactive compound contains NCO functionalities from the isocyanate component and OH functionalities from the polyol component in a ratio of 1.0 to 1.5.

30. The reactive compound of claim 18, wherein the reactive compound additionally comprises one or more additives selected from anti-aging agents, flame retardants, fillers, in the form of chalk or cellulose derivatives, pigments, leveling aids, deaeration aids, processing aids, rheological aids, leveling aids, foaming aids, solvents, carboxylic esters, and crosslinkers.

31. The reactive compound of claim 18, wherein the reactive compound is applied to a polyurethane layer by reacting the isocyanate component with the polyol component to form a polyurethane.

32. The reactive compound of claim 31, the polyurethane layer has a thickness of at least 100 μm.

33. The reactive compound of claim 32, the polyurethane layer has on one side a visually recognizable structuring, in the form of embossing that imitates the skin side of leather.

34. A method for producing a polyurethane layer, the method comprising:
applying a reactive compound to a substrate;
heating the reactive compound to react isocyanate and polyol components with the formation of the polyurethane layer, to a temperature above the melting temperature of the diketo compound present in the reactive compound; and
removing the substrate from the polyurethane layer.

35. The method of claim 34, further comprising arranging a backing layer to aside of the polyurethane layer.

36. The method of claim 34, further comprising arranging an adhesive layer between the polyurethane layer and the backing layer and applying a lacquer layer to a second side of the polyurethane layer.

37. The method of claim 36, further comprising using a mixture of a metal-based catalyst based on a salt or an organometallic compound and a diketo compound having a melting point of 15° C. as a catalyst system for a reaction of polyols and polyisocyanates.
